(19) United States
(12) Patent Application Publication
(10) Pub. No.: US 2007/0156862 A1
(43) Pub. Date: Jul. 5, 2007

(54) Computer system

(76) Inventors: Tsutomu Yamada, Hitachinaka (JP); Hideaki Suzuki, Hitachi (JP); Hiromichi Endoh, Hitachi (JP); Satoru Funaki, Hitachi (JP); Tatsuya Maruyama, Hitachi (JP); Hisanori Nonaka, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/645,609

(22) Filed: Dec. 27, 2006

(30) Foreign Application Priority Data
Dec. 27, 2005 (JP) 2005-373730

(51) Int. Cl. G06F 15/177

(52) U.S. Cl. 709/220

(57) ABSTRACT

In a computer system in which a plurality of computers is connected through a network, each computer is allowed to utilize a function of another computer. There are provided policy information and autonomous configuration client for a client computer and server information and autonomous configuration server for a server computer. The policy information has information about a necessary function, a communication system corresponding to the function and application software. The client computer acquires the necessary function from the policy information and retrieves a server computer on the network. The server computer responds to the function that can be provided. The autonomous configuration client exchanges setting information with the autonomous configuration server and autonomously sets the communication system and the application software. The client computer utilizes the necessary function.

### BACKGROUND OF THE INVENTION

This invention relates to a connection configuration of a plurality of computers, and particularly to a computer system in which each of computers autonomously discovers mutual functions to utilize a necessary function.

A Universal Plug and Play (UPnP) system (hereinafter called a “Known example 1”) described in UPnP Forum “UPnP Device Architecture”, http://www.upnp.org/ is known about a system in which a certain computer discovers and utilizes a function of other computers in a network constituted by a plurality of computers.

Known example 1 relates to a system in which a first computer connected to a network utilizes functions of other computers connected to the same network. When a personal computer (PC) utilizes a printer (having a computer and the UPnP function) connected to the same network, for example, Known example 1 relates to configuration control for automatically discovering and utilizing the printer.

To discover and utilize a desired function among these computers, Known example 1 specifies the following five main functions. The first is a discovery function. A connected computer advertises the function of its own or the function of retrieving those functions which it requires. The second is a description function. A computer providing the function explains an access procedure to the function and the detail of the function. The third is a control function. A computer receives and processes a control message described by Extensible Markup Language (XML). The fourth is an eventing function. It is the function of reporting a status change in a computer (such as ink shortage of the printer) to an associated computer. The fifth is a presentation function. It is the function of setting and executing the functions of the computers through a Web browser, for example.

These functions are constituted by standard network technologies typified by Hyper Text Transfer Protocol (HTTP) and Simple Object Access Protocol (SOAP) and stipulated by standardization organizations such as Internet Engineering Task Force (IETF) and World Wide Web Consortium (W3C).

On the other hand, a technology described in JP-A-2000-259522 (hereinafter called “Known example 2”) represents a technology for acquiring and setting information of other computers in a network system including a plurality of computers.

Known example 2 relates to a system that selects a suitable access system in accordance with the kind of information when a network management agent apparatus gains access to information of other communication apparatuses, and executes information transfer.

However, these known examples are not free from the following problems.

In other words, Known example 1 discloses a system for retrieving and setting the functions of other computers but does not at all consider a communication system among computers other than HTTP and SOAP.

A simple control function of setting or acquiring a status value of a timepiece, for example, can be easily accomplished by utilizing the system of Known example 1. However, in order for the first computer to utilize the function of the mass storage device, the second computer has, the problem of performance occurs when communication is made by HTTP or SOAP stipulated by Known example 1 alone. As for the data storage and acquisition to and from the mass storage device, it is preferred to utilize a Network File System (NFS) protocol or a Server Message Block (SMB) protocol.

When the first computer has to select a communication system other than HTTP or SOAP so as to utilize the function of the second computer, however, the communication system must be determined separately.

The correspondence between application software operating on the first computer and the communication system utilized may be versatile when the first computer utilizes the function of the second computer. A system for managing this correspondence between the application software and the communication system is another problem that is yet to be solved.

Furthermore, let's consider the construction in which a plurality of embedded computers are connected through a network and mutually utilize their functions, for example. Generally, the storage capacity of the embedded computers is limited in comparison with that of a PC or a server computer. However, a system capable of managing the correspondence relationship between application software and a communication system capable of utilizing such embedded computers is not known.

Known example 1 does not either disclose a system for selecting the functions of the second computer from the first computer and a system for utilizing the functions when the functions provided by the second computer are variable. Let's consider the case where the second computer can provide a plurality of functions as a communication apparatus (“simple router”, “Network Address Translation (NAT) router” or “HTTP server”), for example. A system that enables the first computer to activate and utilize at least one functions of a plurality of functions of the second computer is not disclosed.

On the other hand, Known example 2 discloses the access system corresponding to the kind of management information but does not take the correspondence relationship between the application software and the access system into consideration. Therefore, the problems described above must yet be solved, too, in order for the first computer to utilize the mass storage device function of the second computer, for example.

### SUMMARY OF THE INVENTION

In view of the problems described above, an object of the present invention is to provide a system for managing the correspondence relationship between application software for utilizing functions of a second computer and a communication system utilized when a first computer utilizes the functions of the second computer in a computer system constituted by a plurality of computers connected through a network.

To solve the problems described above, the invention provides a computer system having a plurality of computers connected through a network, wherein a first computer includes a server computer having a communication portion connected to the network, for executing communication with other computers, a server information table having information about a function the first computer can provide by itself, a communication system for utilizing the function and application software for utilizing the function, and an autonomous configuration server function for acquiring the function the first computer can provide by itself from the server information table in response to a function retrieval request from the other computer, and receiving and setting the setting request about the function, and wherein the server computer autonomously processes the function retrieval request and the setting request from the other computers.

To solve the problems described above, the invention provides a computer system having a plurality of computers connected through a network, wherein a second computer includes a client computer having a communication portion connected to the network, for executing communication with other computers, a policy information table having information about a function required by the second computer by itself, a communication system for utilizing the function and application software for utilizing the function, and an autonomous configuration client function for acquiring the required function from the policy information table, outputting a function retrieval request to other computers through the communication portion and outputting a setting request for utilizing the function through the communication portion when the required function is discovered, and wherein the client computer autonomously discovers and utilizes the functions of the other computers.

To solve the problems described above, the invention further provides a computer system having a plurality of computers connected through a network, wherein a first computer includes a server computer having a communication portion connected to the network, for executing communication with other computers, a server information table having information about a function the first computer can provide by itself, a communication system for utilizing the function and application software for utilizing the function, and an autonomous configuration server function for acquiring the function the first computer can provide by itself from the server information table in response to a function retrieval request from the other computer, and receiving and setting the setting request about the function, and wherein a second computer includes a client computer having a communication portion connected to the network, for executing communication with other computers, a policy information table having information about a function required by the second computer by itself, a communication system for utilizing the function and application software for utilizing the function, and an autonomous configuration client function for acquiring the required function from the policy information table, outputting a function retrieval request to other computers through the communication portion and outputting a setting request for utilizing the function when the required function is discovered, and wherein the second computer autonomously discovers and utilizes the functions of the first computers.

In the computer system according to the invention described above, the server computer has server information setting means for modifying the server information table and updates the server information table.

In the computer system according to the invention described above, the client computer has policy information setting means for modifying the policy information table and updates the policy information table.

In the computer system according to the invention described above, the server computer accepts a modify request for the server information table through HTTP.

In the computer system according to the invention described above, the client computer accepts a modify request for the policy information table through HTTP.

To solve the problems described above, the invention further provides a computer system having a plurality of computers connected through a network, wherein a first computer includes a server computer having a plurality of communication portions connected to the network, for executing communication with other computers, a server information table having a function the first computer can provide by itself, a communication system for utilizing the function, application software for utilizing the function and communication portion information providing the function, and an autonomous configuration server function for acquiring the function the first computer can provide by itself from the server information table for a request from the communication portion coincident with the communication portion information in response to a function retrieval request from the other computer, and receiving and setting the setting request about the function, and wherein the server computer autonomously processes the function retrieval request and the setting request from the other computers.

To solve the problems described above, the invention provides a computer system having a plurality of computers connected through a network, wherein a second computer includes a client computer having a plurality of communication portions connected to the network, for executing communication with other computers, a policy information table having information about a function required by the second computer by itself, a communication system for utilizing the function, application software for utilizing the function and communication portion information for utilizing the function, and an autonomous configuration client function for acquiring the required function from the policy information table, outputting a function retrieval request for other computers through the communication portion coincident with the communication portion information and outputting a setting request for utilizing the function when the required function is discovered, and wherein the client computer autonomously discovers and utilizes the functions of the other computers.

To solve the problems described above, the invention further provides a computer system having a plurality of computers connected through a network, wherein a first computer includes a server computer having a plurality of communication portions connected to the network, for executing communication with other computers, a server information table having information about a function the first computer can provide by itself, a communication system for utilizing the function, application software for utilizing the function and communication information providing the function, and an autonomous configuration server function for acquiring the function the first computer can provide by itself from the server information table for a request from a communication portion coincident with the communication portion information in response to a function retrieval request from other computers, and receiving and setting the setting request about the function, and wherein a second computer includes a client computer having a plurality of communication portions connected to the network, for executing communication with other computers, a policy information table having information about a function required by the second computer by itself, a communication system for utilizing the function, application software for utilizing the function and communication portion information for utilizing the function, and an autonomous configuration client function for acquiring the required function from the policy information table, outputting a function retrieval request to other computers from a communication portion coincident with the communication portion information, and outputting a setting request for utilizing the function when the required function is discovered, and wherein the second computer autonomously discovers and utilizes the functions of the first computers.

In the computer system according to the invention, the server computer has server information setting means for modifying the server information table, and updates the server information table.

In the computer system according to the invention, the client computer has policy information setting means for modifying the policy information table, and updates the policy information table.

In the computer system according to the invention, the server computer accepts a modify request for the server information table by HTTP.

In the computer system according to the invention, the client computer accepts a modify request for the policy information table by HTTP.

In a computer system constituted by a plurality of computers connected through a network according to the invention, each computer can autonomously retrieve a computer having a required function, can set necessary setting and can utilize the function. As a result, a user of the computer can utilize an integrated computer system by merely connecting a plurality of computers to a network without taking complicated setting into consideration.

Other objects, features and advantages of the invention will become apparent from the following description of the embodiments of the invention taken in conjunction with the accompanying drawings.

### BRIEF DESCRIPTION OF THE DRAWINGS

FIG. 1 shows a construction of a computer system according to a first embodiment of the invention;

FIG. 2 is a flowchart for initialization of a client computer in the first embodiment;

FIG. 3 is a flowchart for the initialization of a server computer in the first embodiment;

FIG. 4 shows a construction of policy information in the first embodiment;

FIG. 5 shows a construction of a configuration control client in the first embodiment;

FIG. 6 is a flowchart for a processing of the configuration control client in the first embodiment;

FIG. 7 is a flowchart for a processing of an autonomous configuration control client in the first embodiment;

FIG. 8 shows a server construction in the first embodiment;

FIG. 9 shows a construction of a configuration control server in the first embodiment;

FIG. 10 is a flowchart for a processing of service retrieval response means in the first embodiment;

FIG. 11 is a flowchart for a processing of service setting response means in the first embodiment;

FIG. 12 is a flowchart for a processing of an autonomous configuration server at its start-up in the first embodiment;

FIG. 13 is a flowchart for a processing of an autonomous configuration server at its setting request in the first embodiment;

FIG. 14 shows a setting request contained in a setting request message in the first embodiment;

FIG. 15 is a sequence diagram showing operations until functions are utilized among elements of the computer system;

FIG. 16 shows a construction of a computer system according to a second embodiment of the invention;

FIG. 17 shows a construction of policy setting means in a second embodiment;

FIGS. 18A and 18B show screen views or windows of a policy setting tool in the second embodiment;

FIG. 19 shows screens of reference, modification and addition of the policy setting tool in the second embodiment;

FIG. 20 shows a construction of a computer system in a third embodiment; and

FIG. 21 shows a construction of policy information in the third embodiment.

### DESCRIPTION OF THE EMBODIMENTS

In a computer system constituted by a plurality of computers connected to one another through a network, the invention relates to a technology that enables a first computer to autonomously utilize a function of a second computer.

### Embodiment 1

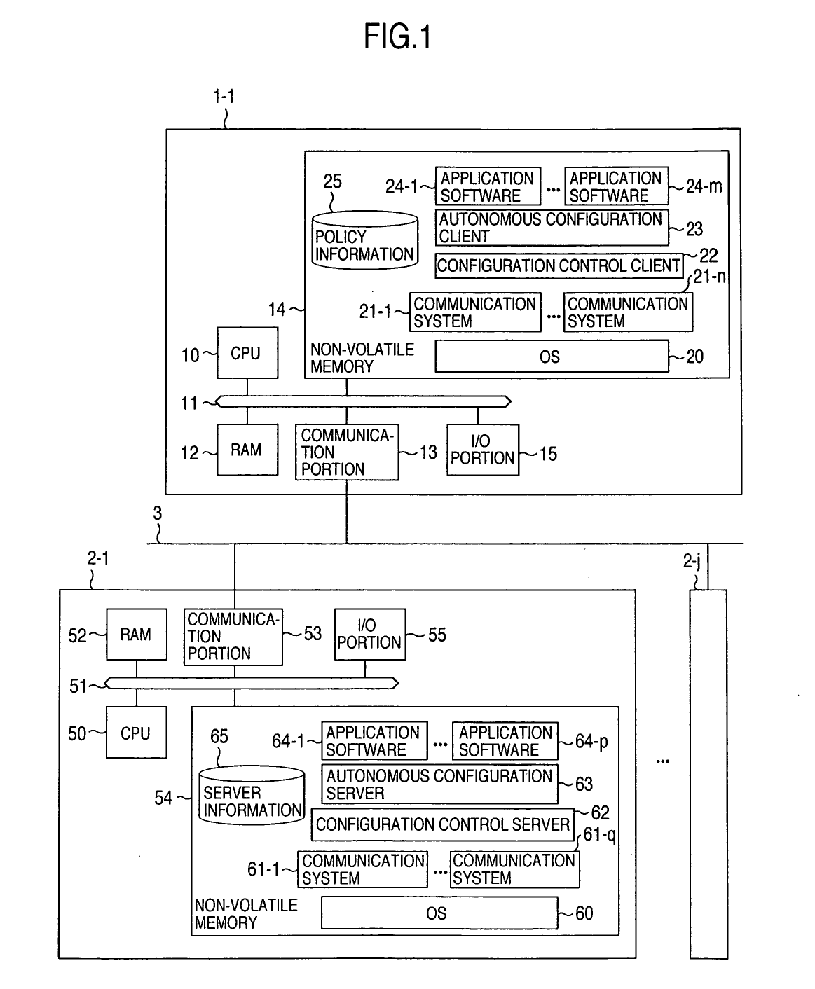

FIG. 1 shows an overall construction of a computer system according to a first embodiment of the invention. In this embodiment, explanation will be given on the form in which one client computer utilizes the functions of a plurality of server computers. One set of a client computer 1-1 and j sets of server computers 2-1 to 2-j are connected to one another through a network 3. The suffixes of the client computer and the server computer correspond to the order of the number of sets.

The client computer 1-1 is the one that utilizes the functions of the server computers 2-1 to 2-j. In this embodiment, explanation will be given on the construction in which the client computer 1-1 utilizes the functions of other computers but the effect of the invention is in no way limited even when the client computer 1-1 has the function and the construction of the server computer.

The server computers 2-1 through 2-j provide the same kind or different kind of functions to the client computer 1-1. More concretely, the functions provided by the server computers include a mass storage function by a hard disk or a flash memory, a high speed operation function providing high-speed large-scale operations, a real time control function for controlling external devices on a real time basis, a wireless communication function for providing an interface of wireless communication, a cipher communication function for providing an interface of cipher communication, and so forth. These functions are generally achieved and provided by an I/O portion 55 alone or by its combination with other elements. The cipher communication function, for example, may be provided as an application function of a communication portion 53.

A plurality of server computers having such functions may be prepared and provided, whenever necessary. Though the explanation will be given in detail mainly on the basis of the construction of the server computer 2-1, the operation is also the same for the server computers 2-2 through 2-j.

One of the features of this invention resides in that the client computer 1-1 autonomously selects and makes most of optimal setting sequence, communication system and application software and utilizes the functions of the server computers 2-1 to 2-j.

Next, the outline of the construction of each computer will be explained.

The client computer 1-1 includes a CPU 10 as a processor, an RAM 12 as a volatile storage device (memory), a communication portion 13, a non-volatile memory 14 and an I/O portion 15 having various input/output devices. These system elements exchange data through an internal bus 11.

The CPU 10 in the client computer 1-1 reads out an OS 20 held by the non-volatile memory 14 and instructions and constants of various kinds of software, stores and reads or writes these instructions and constants into and from the RAM 12, whenever necessary, and executes a software processing.

The communication portion 13 executes a processing for sending the data requested from the CPU 10 to the network through the internal bus 11 and a processing for reporting the processing received from the network to the CPU 10. The present invention is not limited by the network technology utilized as the network 3. The technologies that can be utilized as the network 3 include serial transfer technologies by Ethernet (R) as a wired network technology, RS485 and optical fibers and parallel technologies such as SCSI and PCI bus. Wireless network technologies stipulated by IEEE802.11, IEEE802.15.1 and IEEE802.15.4 can be similarly utilized.

The status change of the communication portion 13 or the I/O portion 15 of its own and an occurrence of the processing request are reported by an interrupt signal (not shown) to the CPU 10 or recognized from the CPU 10 by polling. The CPU 10 executes the software described above, the interrupt report processing from the I/O portion 15 with the communication portion 13 and the polling recognition processing and accomplishes the intended function.

The communication systems 21-1 through 21-n are communication software that operate on the OS 20 and process the communication system (protocol) through the communication portion 13. Examples of the communication systems are HTTP, NFS and Internet Protocol (IP). Necessary communication systems are prepared in advance in such a fashion as to correspond to the functions required by the client computer 1-1.

Application software 24-1 through 24-m are those which operate on the OS 20. The application software is prepared to satisfy the functions required by the client computer 1-1. Examples include a Web browser, a remote file system and route information software.

The operation of various kinds of software stored in the CPU 10 and in the non-volatile memory 14 will be later explained in detail.

Similarly, each of the server computers 2-1 to 2-j includes a CPU 50 as a processor, an RAM 52 as a volatile storage device, a communication portion 53, a non-volatile memory 54 and an I/O portion 55 constituted by various input/output devices. These elements exchange data through an internal bus 51. The operations among these elements are the same as the operations among the elements in the client computer. Operations of various kinds of software stored in the CPU 50 and the non-volatile memory 54 will be later explained in detail.

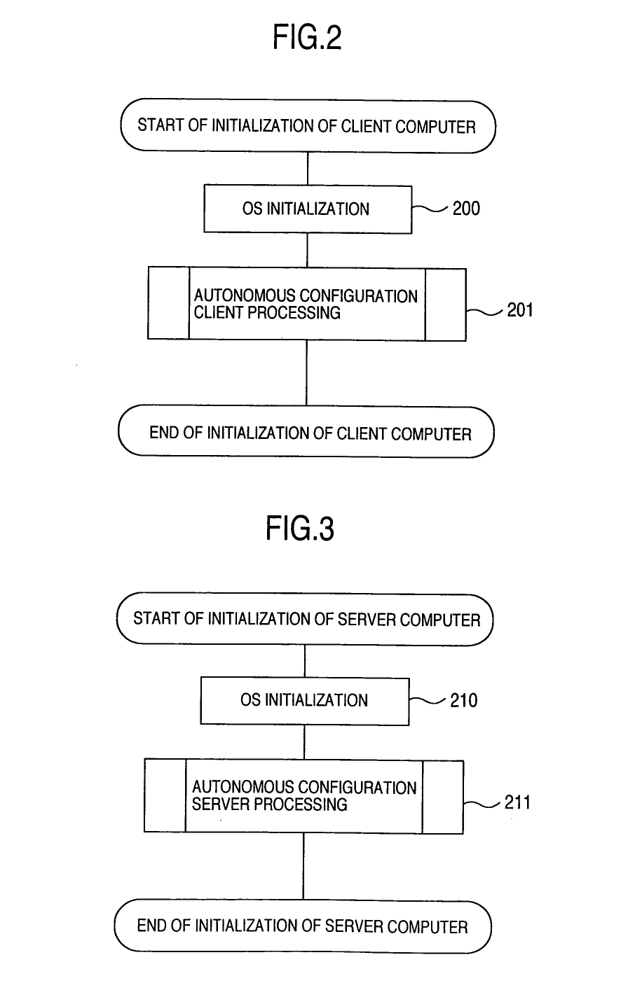

FIG. 2 shows a flowchart of an initialization operation of the client computer. The procedure of the client computer for utilizing the functions of the server computer will be explained with reference to FIG. 2.

The CPU 10 of the client computer 1-1 first executes the OS 20 and initializes various resources (RAM 12, communication portion 13, I/O portion 15) (step 200). Next, to acquire the necessary functions from the server computers 2-1 to 2-j on the network, the CPU 10 executes an autonomous configuration client 23 on the basis of policy information (step 201). The policy information contains the functions necessary for the client computer 1-1 and information of the corresponding communication system and the application software. The autonomous configuration client 23 acquires the necessary information from the policy information 25 and asks the configuration control client 22 to retrieve the server computer having the corresponding function. After the configuration control client 22 acquires the server computer corresponding to the function, necessary initial setting is carried out. When the initialization of the functions is completed, the CPU 10 reports the communication system to be utilized to the application software corresponding to the function and executes start-up. The detail of these procedures will be explained later.

The initialization processing of the client computer 1-1 is completed as described above.

FIG. 3 shows a flowchart of the initialization processing of the server computer. The initialization operation of the server computer will be explained with reference to FIG. 3.

The CPU 50 of the server computer 2-1 first executes the OS 60 and initializes various resources (RAM 52, communication portion 53, I/O portion 55) (step 210). Next, an autonomous configuration server 63 is started up (step 211). The autonomous configuration server 63 acquires provided function information contained in the server information 65, starts up the configuration control server 62 to report the provided function information and prepares for the function retrieval request from the client computer. The initialization operation of the server computer 2-1 is thus completed.

Next, the operations and constructions of various kinds of software will be explained in detail.

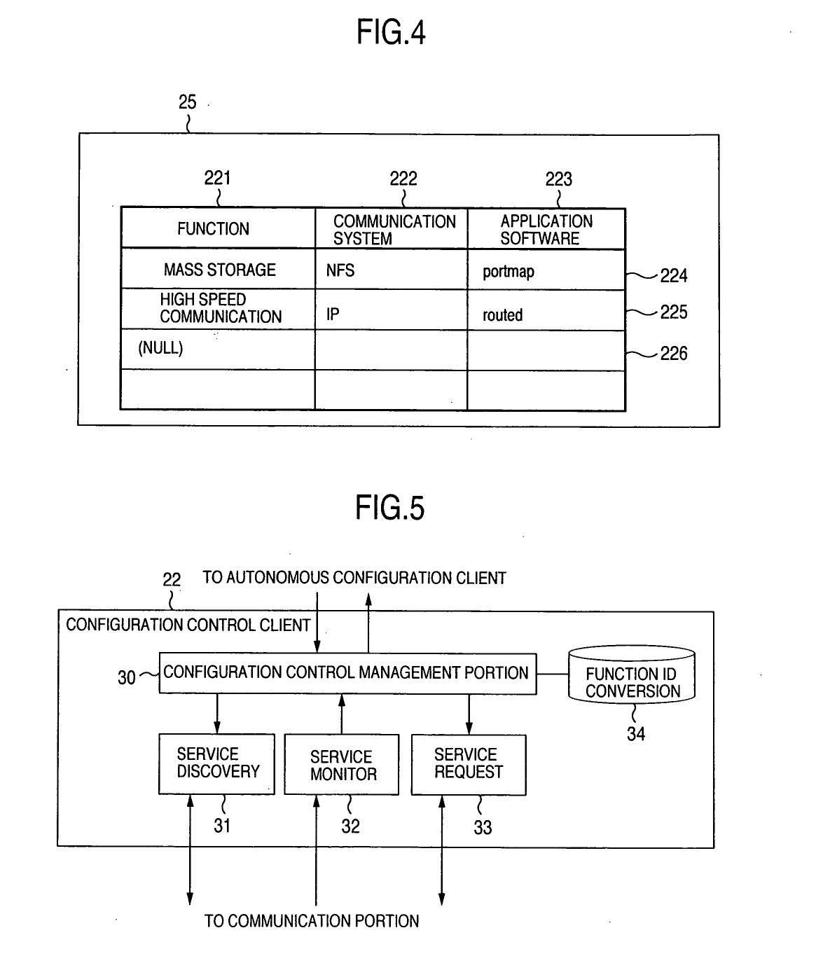

FIG. 4 shows the construction of the policy information 25.

The policy information 25 includes information on the function 221 required by the client computer 1-1, the communication system 222 and the application software 223.

The example shown in FIG. 4 describes two functions and a terminal symbol (NULL). Description 224 about “mass storage” and description 225 about “high speed communication” are shown as the functions required by the client computer 1-1.

Description 226 about the terminal symbol (NULL, binary value “0”) represents that the function required by the client computer 1-1 no longer exists. The terminal symbol need not be limited to the NULL symbol as long as the symbol can clarify the terminal.

The description 224 represents that the client computer 1-1 requires the “mass storage” function, the communication system is NFS and the application software utilized is “portmap”.

The description 225 represents that the client computer 1-1 needs “high speed communication” function, the communication system is IP and the application software utilized is “routed”.

These kinds of information are handed over to the autonomous configuration client to be later described and are used for retrieving the computers having such functions and for the subsequent start-up processing of the application software.

The policy information 25 in this embodiment is prepared in advance as a file. The form of the file to be recorded may be a text file system partitioned by tabs and commas or a binary file system. The policy information 25 need not always be an independent file but may be a form contained in other setting information or a script file.

The CPU 10 can make quick transition to the retrieval processing of the required function soon after the start-up of the OS 20 of the client computer 1-1 when the policy information 25 is stored in advance in the client computer 1-1.

FIG. 5 shows the construction of the configuration control client 22. The configuration control client 22 includes a configuration control management portion 30, service discovery means 31, service monitor means 32, service request means 33 and a function ID conversion database 34. The term “service” means the “function” provided by the server computers and has the same meaning as the “function”.

The configuration control management portion 30 receives the request from the autonomous configuration client 23 and replies whether or not the required function can be used. The service discovery means 31 receives the retrieval request from the configuration control management portion 30, retrieves the required function through the communication portion 13 and replies the result to the configuration control management portion 30.

The service monitor means 32 monitors the service activation message communicated from the communication portion 13 and inspects whether or not the message relates to the function for which monitor request is made from the configuration control management portion 30. When finding the activation message about the function for which monitor request is made, the service monitor means 32 reports this finding to the configuration control management portion 30.

The service request means 33 generates a setting request for making the function reported from the configuration control management portion 30 utilizable to the computer having such a function. As a result, utilizability is replied to the configuration control management portion 30.

A corresponding service ID is prepared for each function. The network 3 retrieves the function by using the service ID. A function ID conversion database 34 has correspondence information between the function name (character string) and the service ID that is reported from the autonomous configuration client 23.

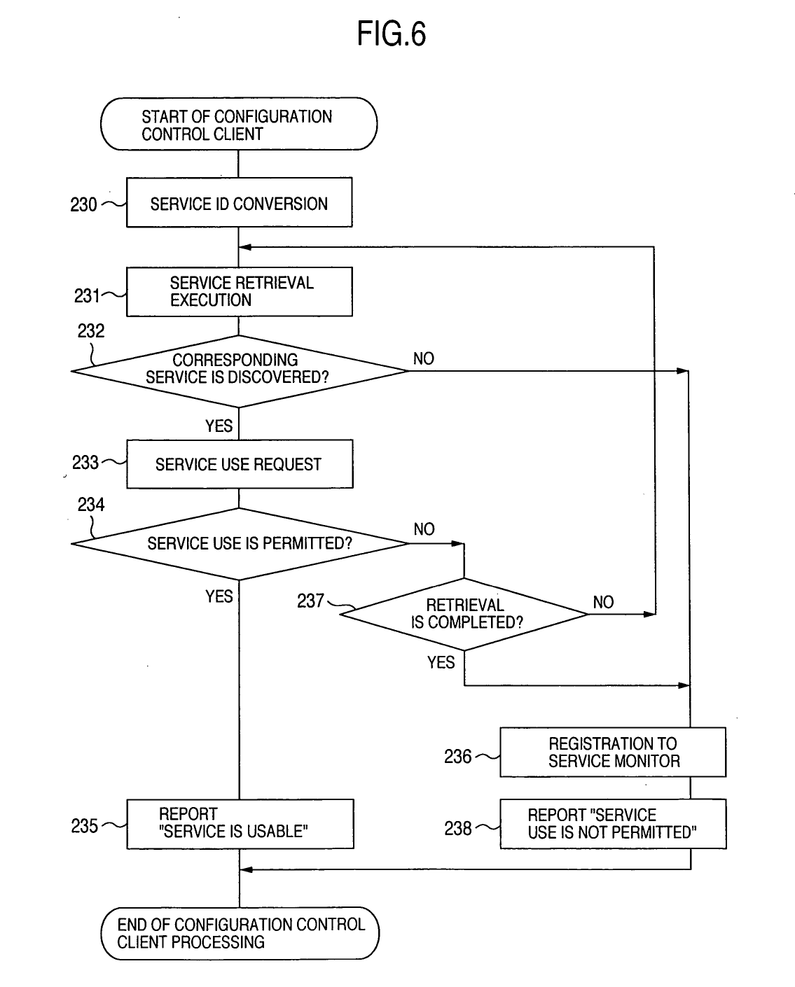

FIG. 6 is a flowchart showing the operation of the configuration control client 22. The operation of the configuration control client 22 will be described with reference to FIG. 6.

The configuration control management portion 30 starts operating after it receives the request for the service retrieval from the autonomous configuration client 23. The configuration control management portion 30 first modifies the function name to the corresponding service ID by using the function ID conversion database 34 (step 230). The configuration control management portion 30 then requires service discovery means 31 to retrieve the function (step 231). The retrieval request of the function is handed over to the service discovery means 31 with the service ID. The service discovery means 31 generates the message for retrieving the function and broadcasts the message on the network 3 through the communication portion 13 or inquires one by one the computers as the objects.

As a result, whether or not the corresponding service can be discovered is judged (step 232). When the service is not discovered, the service monitor means 32 is set so that it can monitor the information about the corresponding service on the network 3 (step 236). The flow then undergoes transition to step 238.

When the corresponding service is discovered, on the other hand, a setting request is made so that the corresponding function of the corresponding server computer can be utilized (step 233). Thereafter, whether or not the setting request is accepted by the server computer is judged (step 234).

As a result, when the use permission of the service is acquired, completion of the use preparation of the service is reported to the autonomous configuration client 23 (step 235).

When the use permission of the service is not acquired, on the other hand, whether or not the result from all the server computers is acquired is judged to search other applicant (step 237). Step 236 is executed when other applicant does not exist, that is, when the result is obtained from all the server computers. Thereafter, the report is given to the autonomous configuration client 23 to the effect that the corresponding service cannot be used (step 238). On the other hand, the flow returns to step 231 and retrieval of other applicant is continued when retrieval of all the server computers is not yet completed.

The service discovery means 31, the service monitor means 32 and the service request means 33 described above use a communication system capable of establishing matching between the configuration control client 22 and the configuration control server 62. When Ethernet (R) is used as the network 3, for example, these communication means are appropriately achieved by a socket communication program that uses a TCP port or a UDP port of the IP protocol.

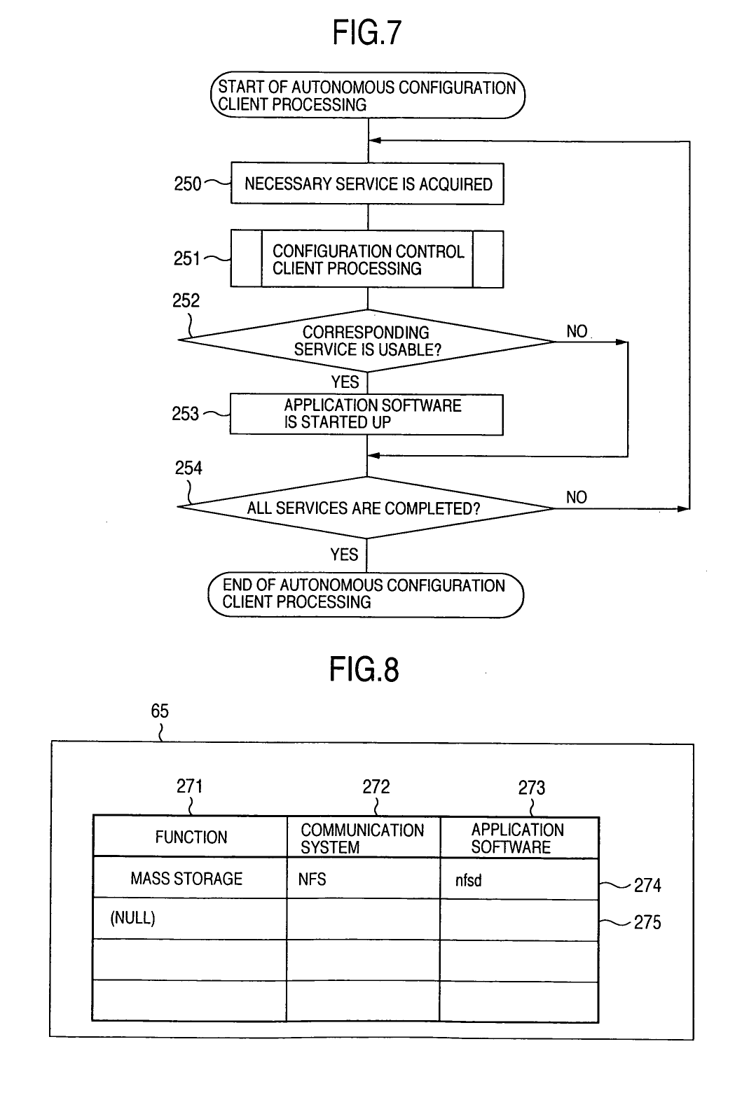

FIG. 7 is a flowchart showing the operation of the autonomous configuration client. The processing in FIG. 7 corresponds to the processing of step 201 in FIG. 2.

First, the function required by the client computer 1-1 is acquired from the policy information 25 (step 250). Next, the autonomous configuration client 23 reports the acquired function (service) to the configuration control client 22 and asks the processing (step 251). Step 251 corresponds to the processing shown in FIG. 6.

The response from the configuration control client 22 is judged about the function reported (step 252).

When the reply “corresponding service is usable” is acquired, the application software corresponding to this function and the corresponding communication system are acquired from the policy information 25. The communication system is reported to the application software and the start-up processing of the application software is executed (step 253). Thereafter, the flow shifts to step 254.

When the reply “corresponding service is not usable” is obtained, whether or not the retrieval processing is executed for all services is judged (step 254). The flow shifts to step 250 when retrieval for all the services is not yet completed, and the processing of the autonomous configuration client is completed when retrieval is completed for all the services.

FIG. 8 shows the construction of the server information 65.

The server information 65 has a construction similar to that of the policy information 25. In other words, the service information 65 has information about a function 271 the server computer 2-1 can provide, a communication system 272 and application information 273.

Description about one function and a terminal symbol (NULL) are described in the example shown in FIG. 8, and description 274 about “mass storage” is shown as the function the server computer 2-1 can provide.

The description 275 about the terminal symbol (NULL, binary value “0”) represents that the function the server computer 2-1 can provide does not exist any more. The terminal symbol is not limited to the NULL symbol as long as the symbol can represent the terminal.

The description 274 represents that the server computer 2-1 can provide the “mass storage” function, the communication system is NFS and the application software utilized is “nfsd”.

These kinds of information are handed over to the later-appearing autonomous configuration server and are used for the response to the retrieval of the computers having such a function and for the subsequent start-up processing of the application software.

The server information 65 in this embodiment is prepared in advance as a file. The file form to be recorded may be the text file form partitioned by tabs and commas or the binary file form. The server information 65 need not always be an independent file but may be a form that is contained in other setting information or a script file.

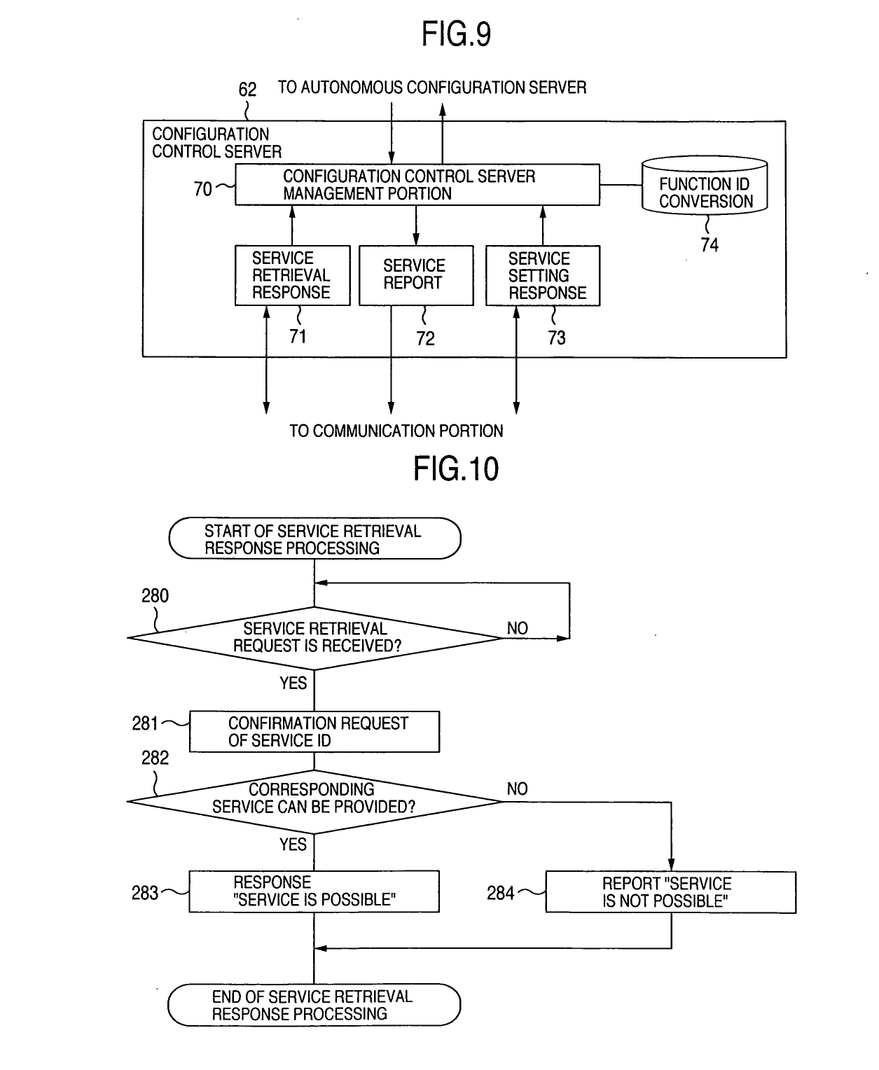

FIG. 9 shows a construction of a configuration control server 62. The configuration control server 62 includes a configuration control server management portion 70, service retrieval response means 71, service report means 72, service setting response means 73 and a function ID conversion database 74.

The configuration control server management portion 70 bears the role of the interface with the autonomous configuration server 63 and executes the processing of the configuration control server 62 as a whole. The operation in detail will be later described.

The service retrieval response means 71 receives the retrieval request from the client computer 1-1 through the communication portion 53 and replies to the client computer whether or not the required function is utilizable.

The service report means 72 outputs an activation message about the provided function reported from the autonomous configuration server through the communication portion 53. This function is effective particularly when the server computer is started up while the client computer 1-1 has already operated. When the client computer waits for the function the server computer can provide, the report by the activation message from the service report means 72 is effective for the client computer.

The service setting response means 73 receives the service setting request from the client computer 1-1 and reports the setting request to the autonomous configuration server 63. The service setting response means 73 thereafter replies to the requesting client computer 1-1 whether or not setting can be made.

The function ID conversion database 74 has the correspondence relationship information between the function name (character string) and the service ID that is reported from the autonomous configuration server 23, and has a function similar to that of the function ID conversion database 34.

A communication system that establishes matching between the configuration control client 22 and the configuration control server 62 is used for the service retrieval response means 71 and the service setting response means 73. Besides the method described about the configuration control client 22, these means may be packaged by the combination of an HTTP server and a Common Gateway Interface (CGI) program, for example.

FIG. 10 is a flowchart of the operation of the service retrieval response means 71.

The service retrieval response means 71 judges, and replies to, the retrieval request from the client computer 1-1 as to whether or not the function can be used. The operation will be hereinafter explained.

The service retrieval response means 71 waits for the service retrieval request from the communication portion 53 (step 280). When the service retrieval request arrives, whether or not the function corresponding to the service ID can be provided is inquired to the configuration control server management portion 70 with the service ID contained in the request message as the key (step 281).

Incidentally, it will be assumed that the configuration control server management portion 70 acquires in advance the information from the autonomous configuration server 63 about the services to which the configuration control server management portion 70 can respond. When the configuration control server 62 is started up by the autonomous configuration server 63, for example, the services that can be provided may be reported in advance.

Whether or not the function corresponding to the service ID can be provided is judged from the result of the inquiry (step 282).

When the corresponding function can be provided, the reply “service can be provided” is replied to the client computer 1-1 generating the retrieval request (step 283).

When the corresponding function cannot be provided, on the other hand, the reply “service cannot be provided” is returned to the client computer 1-1 generating the retrieval request (step 284).

The service retrieval response means 71 judges the retrieval request as described above and sends the response.

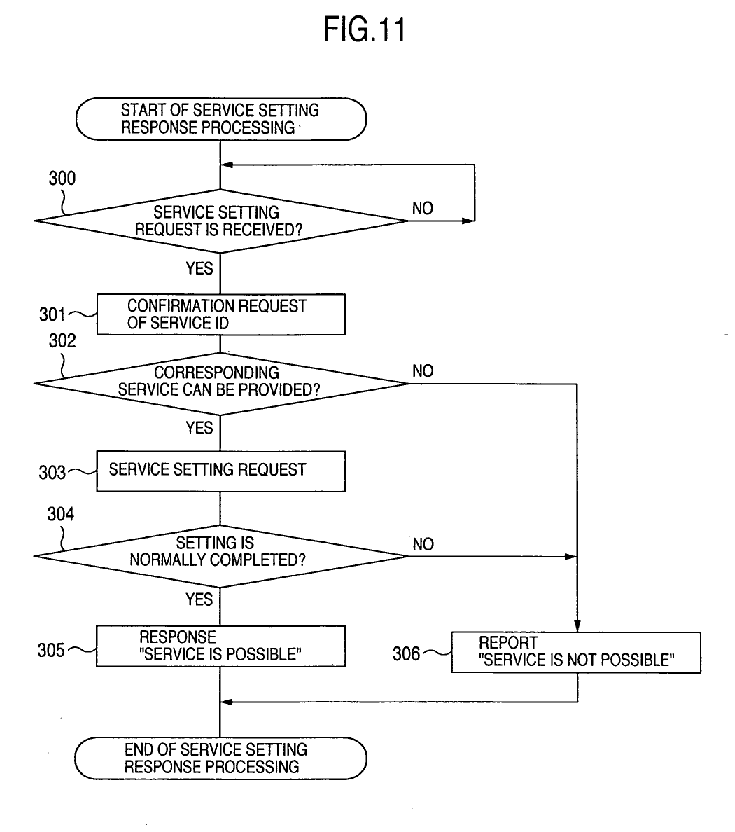

FIG. 11 is a flowchart of the operation of the service setting response means 73.

When the client computer 1-1 uses the function, the service setting response means 73 is used for executing the requested setting operation if the setting request exists prior to the use.

The service setting response means 73 waits for the service retrieval request from the communication portion 53 (step 300). When the service setting request arrives, the service setting response means 73 inquires the configuration control server management portion 70 whether or not the function corresponding to the service ID can be provided, with the service ID contained in the requested message as the key (step 301). Step 301 is executed to discard the setting request corresponding to the function that cannot be provided.

It will be assumed hereby that the configuration control server management portion 70 has already acquired the information about the services to which it can respond, as described above.

Whether or not the function corresponding to the service ID can be provided is judged from the inquiry result (step 302).

The flow shifts to step 306 when the corresponding function cannot be provided.

When the function corresponding to the setting request can be provided, on the other hand, the message of the setting request is handed over to the configuration control server management portion 70 and setting request is made (step 303). The configuration control server management portion 70 outputs the setting request as the request for the autonomous configuration server 63. As a result, the end status of the setting request is returned from the autonomous configuration server 63 to the service setting response means 73 through the configuration control server management portion 70.

The service setting response means 73 judges from the response result whether or not the setting request is normally completed (step 304).

When the setting request is normally completed, the reply is given to the client computer 1-1 transmitting the setting request to the effect that setting is normally finished (step 305).

When the setting request is not normally completed or when it is a setting request for the function that cannot be provided, on the other hand, the reply is given to the client computer 1-1 transmitting the setting request to the effect that the corresponding setting is not possible (step 306).

The service setting reply means 73 executes the setting request of the function and gives the reply as described above.

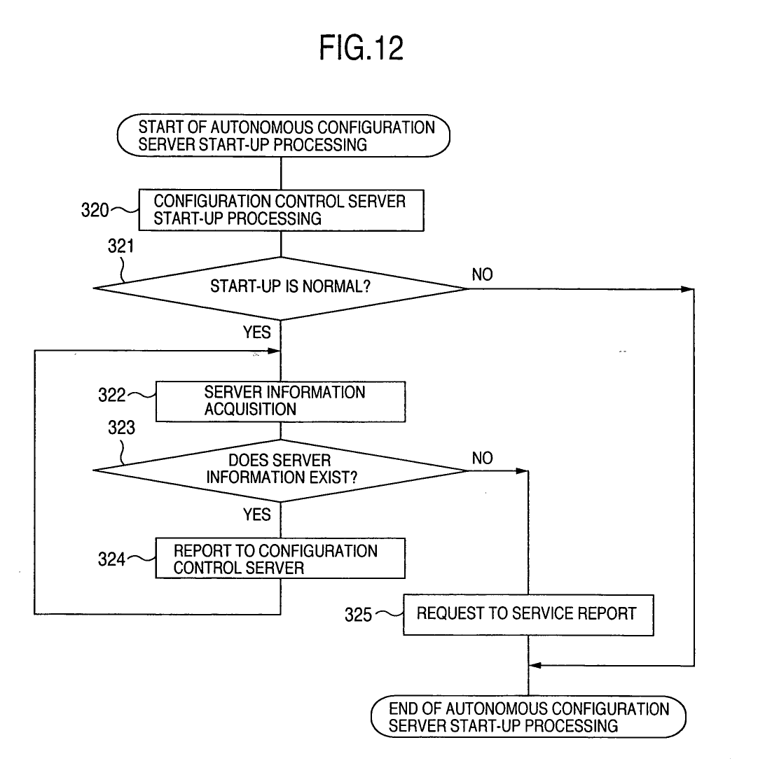

FIG. 12 shows an operation flow when the configuration control server 62 is started up in the autonomous configuration server 63.

The autonomous configuration server 63 starts up the configuration control server 62 and reports to the configuration controls server 62 the functions that can be provided by the corresponding computer.

To begin with, the autonomous configuration server 63 starts up the configuration control server 62 (step 320). After being started up, the configuration control server 62 prepares necessary means (service retrieval response, service report, service setting response, etc.) that is necessary for itself.

As a result, the autonomous configuration server 63 judges whether or not the configuration control server 62 can be normally started up (step 321).

The autonomous configuration server 63 stops as such its operation when the configuration control server 62 cannot be started up normally.

When the configuration control server 62 can be normally started up, on the other hand, the autonomous configuration server 63 looks up the server information 65 and acquires the functions it can provide (step 322).

Here, whether or not any effective information of the function to be acquired exists is judged (step 323). When the function to be acquired no longer exists (when the terminal symbol appears), the request is made to the service report means 72 to report the activation message to the network 3 through the communication portion 53 (step 325). The start-up processing of the autonomous configuration server is thus completed.

When the effective information about the provided function exists, on the other hand, the provided function is reported to the configuration control server 62 and the flow returns to step 322 (step 324).

The autonomous configuration server 63 starts up the configuration control server 62 in the procedure described above.

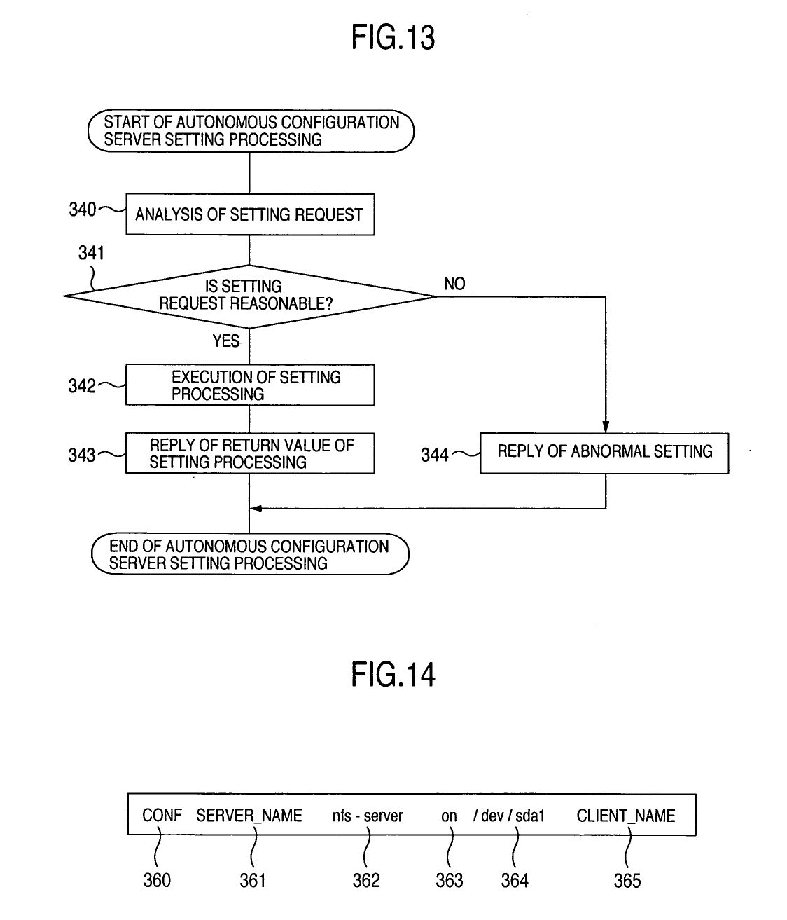

FIG. 13 is a flowchart of the processing for the service setting request in the autonomous configuration server 63.

The autonomous configuration server 63 processes the setting request of the function in accordance with the request from the service setting response means 73 in the configuration control server 62. This flowchart represents the processing after the arrival of the setting request at the autonomous configuration server 63 from the service setting response means 73. The operation will be hereinafter explained.

First, the message of the arriving setting request is analyzed (step 340). As a result, whether or not the form of the message so analyzed is normal is judged (step 341). When the message form is not normal, the reply “message is abnormal” is given (step 344) and this flow is completed.

When the message form is normal, the setting processing corresponding to the setting request is executed (step 342). After the setting processing is executed, the result of setting (return value) is acquired and the reply is given to the service setting response means 73 (step 343).

FIG. 14 shows a message example about the service setting request.

The figure shows an example where the setting request stipulating that the client computer 1-1 desires to utilize the function “mass storage” by NFS arrives.

A character string 360 is a command representing the setting request. A character string 361 represents which server is requested by the command and may be a host name registered to Domain Name Server (DNS) of the server computer or an IP address, for example. Character strings 362 and 363 are the setting requests and represent hereby that the function “nfs-server” is turned “on”. A character string 364 describes a path name of the mass storage in the server computer. It is expressed by a Unix (R) series file designation system. The character string 364 may an abstract expression that can be agreed between the server computer and the client computer such as “DISK” besides the physical expression such as the file designation system. A character string 365 represents a client name of the client computer making the setting request. It may be the host name registered to the DNS or the IP address in the same way as in the case of the server name.

The function can be appropriately set by analyzing the message by the autonomous configuration server 63.

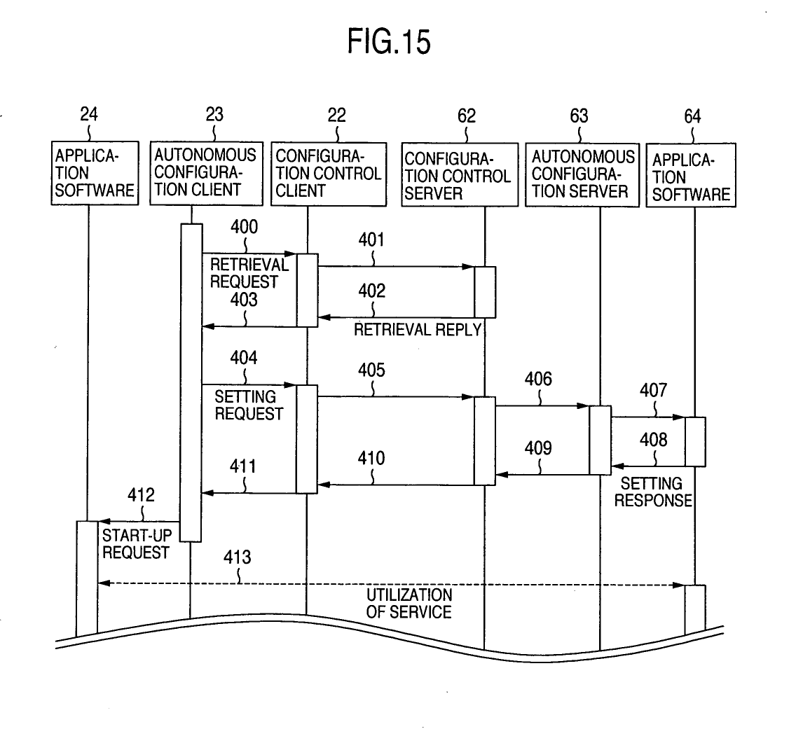

FIG. 15 is a sequence diagram showing the operations of the function retrieval and the setting request between the server computer and the client computer.

FIG. 15 shows the process in which the client computer 1-1 first retrieves the function, the server computer 2-1 then replies that the function can be provided, and the client computer 1-1 utilizes the function in practice.

The operation will be hereinafter explained. First, the autonomous configuration client 23 generates the retrieval request to the configuration control client 22 (step 400).

The configuration control client 22 generates the retrieval request to the configuration control server 62 of the server computer 2-1 (step 401). Since the function that its own computer can provide is in advance reported as described above, the configuration control server 62 responds to the information (step 402). When the retrieval response is acquired from the configuration control server 62, the configuration control client 22 hands over the retrieval response to the autonomous configuration client 23 (step 403). Here, the retrieval response is assumed to represent that the required function is utilizable.

The autonomous configuration client 23 judges that the required function is utilizable in the server computer 2-1. Next, the client computer 1-1 generates the setting request of this function to utilize the function of the server computer 2-1 (step 404). The configuration control client 22 hands over the setting request to the configuration control server 62 (step 405). The configuration control server 62 reports the setting request to the autonomous configuration server 63 (step 406). The autonomous configuration server 63 modifies and sets the setting request so that it is suitable for the application software 64 (step 407). As a result of setting, the response from the application software 64 is returned to the configuration control server 62, the configuration control client 22 and the autonomous configuration client 23 through the autonomous configuration server 63 (step 408 to step 411). As a result, when setting is normally completed, the autonomous configuration client 23 reports the communication system to the application software corresponding to the required function and generates the start-up request (step 412). As a result, the function intended originally can be mutually utilized between the application software 24 and the application software 64 (step 413).

According to the invention, the client computer 1-1 can autonomously retrieve and utilize the function the server computers 2-1 to 2-j has. Particularly, it becomes possible to select application software corresponding to each function in an integrated sequence by using the policy information 25, the autonomous configuration client 23, the configuration control client 22, the server information 65, the autonomous configuration server 63 and the configuration control server 62, and to utilize the function in an appropriate communication system. Therefore, it is possible to utilize the functions of other computers among the computers connected to one another through the network like the initialization and utilization of the I/O devices directly connected to the computers. Because the policy information 25 is a database having simple information, the invention can be applied to the computers having limited storage capacity and limited processing capacity of processors like the embedded computers.

### Embodiment 2

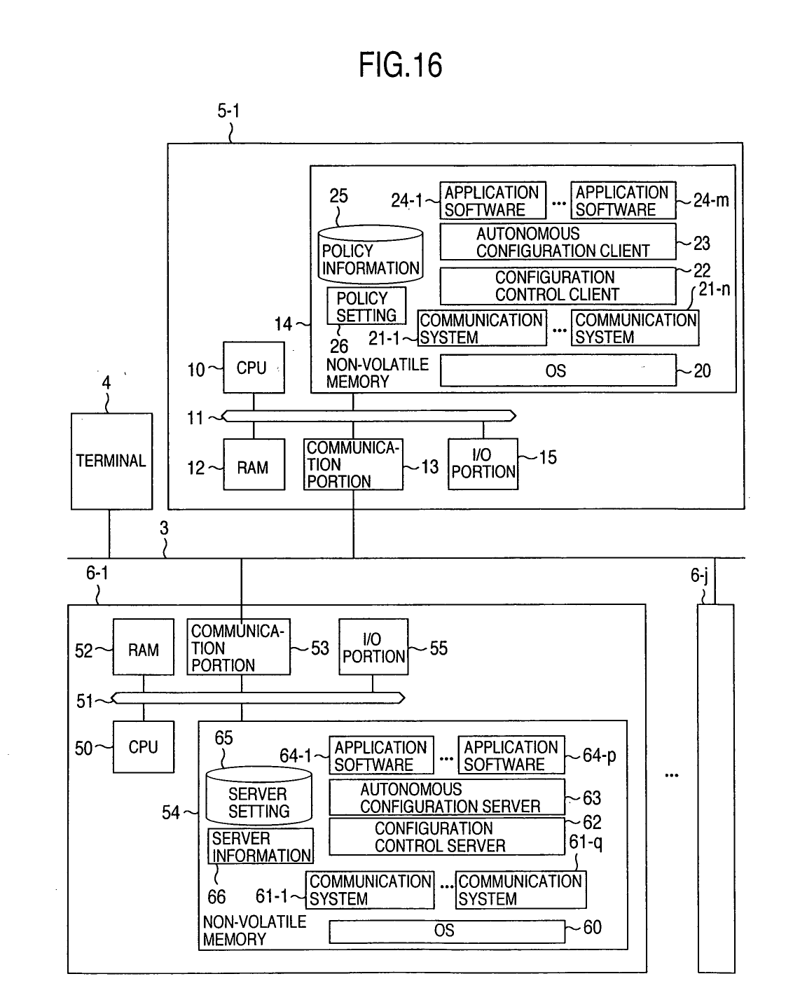

FIG. 16 shows a construction of a computer system according to the second embodiment of the invention. Reference numerals used in this embodiment are the same as the functions and elements explained in the first embodiment unless specified otherwise.

The feature of this embodiment resides in that a terminal 4 is introduced afresh and policy setting means 26 is disposed. The policy setting means 26 is means for setting the policy information 25 in the client computer 5-1 from the terminal 4. Another feature is that server information setting means 66 is disposed, too, so that the server information 65 in the server computers 6-1 to 6-j can be set from the terminal 4.

The terminal 4 is a computer that communicates with the policy setting means 26 or the server information setting means 66 and sets the policy information 25 or the server information 65. The terminal 4 has the function of accepting the input from the user and connecting it to the object computer, the function of displaying the present set value and the function of adding and modifying the set information. The terminal 4 has an interface capable of being connected to the network 3.

The terminal 4 may be a computer that has the functions described above. For example, the terminal 4 is a computer having a Web browser capable of inputting and outputting HTTP, and a suitable example are personal computers (PC) or work stations. The Web browser provided to a cellular telephone or a personal digital assistant (PDA) may be used by suitably controlling the information inputted to and outputted from the Web browser.

In this embodiment, explanation will be given on the assumption that the terminal 4 has an interface that can be connected to the network 3, though the interface is not limited thereto. For example, the terminal 4 is a terminal so constituted as to possess serial transfer such as RS232C or RS422 and to be directly connected to the client computer 5-1 or the server computers 6-1 to 6-j without passing through the network 3. The effect of the invention is not spoiled even when these computers are connected by a Serial Line Internet Protocol (SLIP) or a Point to Point Protocol (PPP) communication system.

In this embodiment, explanation will be given on the assumption that the terminal 4 is an independent computer, too, but the client computer 5-1 and the server computers 6-1 to 6-j may have the functions of the terminal 4. In such a case, each computer must have window output means (not shown) necessary for setting. The computer preferably includes a pointing device (not shown) such as a mouse or a track ball.

The operation of the terminal 4 will be explained with reference to FIG. 16. The operation of the terminal 4 will be explained about the example of setting of the client computer 5-1 but this explanation also holds true of the server computers 6-1 to 6-j.

The policy setting means 26 is read out from the non-volatile memory 14′ and is executed by the CPU 10 in the same way as other software.

The terminal 4 is connected to the policy setting means 26 through the network 3. The terminal 4 then reads out the set value held by the present policy information 25 for the policy setting means 26. The set values include the function that the client computer 5-1 now requires, the communication system corresponding to the function and the list of application software. The user thereafter modifies the set value through the terminal 4 and notifies this modification to the policy setting means 26. The policy setting means 26 reflects the set value modified on the policy information 25 and reports the result to the terminal 4.

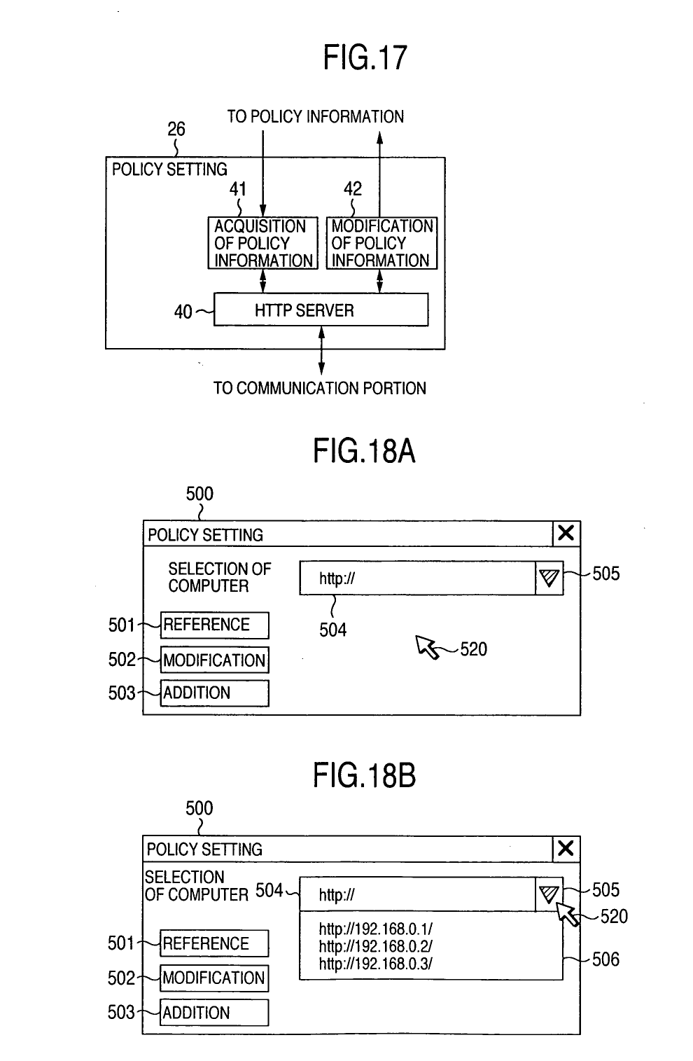

FIG. 17 shows a structural example of the policy setting means 26. This structural example is similarly applicable to the server information setting means 66.

The policy setting means 26 has an HTTP server 40, policy information acquisition means 41 and policy information modify means 42. The policy information acquisition means 41 and the policy information modify means 42 are software that communicate with the HTTP server 40 and are appropriately packaged by CGI or servlet.

The HTTP server 40 responds to the connection request arriving from the terminal 4 through the communication portion 13 and the network 3.

When the policy information acquisition is requested from the terminal 4, this request is generated for the policy information acquisition means 41. The policy information acquisition means 41 acquires information from the policy information 25, modifies or converts the information to the format that can be browsed by the terminal 4, and replies the corresponding information to the HTTP server 40.

When the policy information change is requested from the terminal 4, this request is generated for the policy information modify means 42. The policy information modify means 42 modifies the policy information 25 on the basis of the requested information to be modified.

The policy information modify format may be outputted by either the policy information acquisition means 41 or the policy information modify means 42.

FIGS. 18A and 18B show examples of user reference windows outputted by the terminal 4.

FIG. 18A shows an initial window of a policy setting tool 500 in the terminal 4. Though a system using a dedicated tool is hereby shown, a similar window can be outputted by the Web browser. In such a case, the initial window information is held in the terminal 4 or another computer (not shown), and the initial window information may well be looked up at the start-up of the Web browser.

The window of the policy setting tool 500 includes a reference button 501 for instructing reference to the policy information held by the client computer, a modify button 502 for requiring modification of the policy information, an addition button 503 for adding the policy information, a computer select menu 504 for selecting a client computer that browses the policy information and a computer select menu button 505. The user moves and operates the cursor 520 through the pointing device (not shown) such as a mouse or a track ball and selects and pushes down the object button or menu.

FIG. 18B shows an output window when the computer selection menu button 505 is pushed by the cursor 520 on the window of the policy setting tool 500.

A pull-down menu 506 is outputted when the computer select menu button 505 is pushed down. The pull-down menu 506 describes the list of the computers as the edition object of the policy information. When the object computer is hereby selected by the cursor 520, the selected computer is displayed on the computer select menu 504 and the subsequent operations can be designated as the operations of this computer.

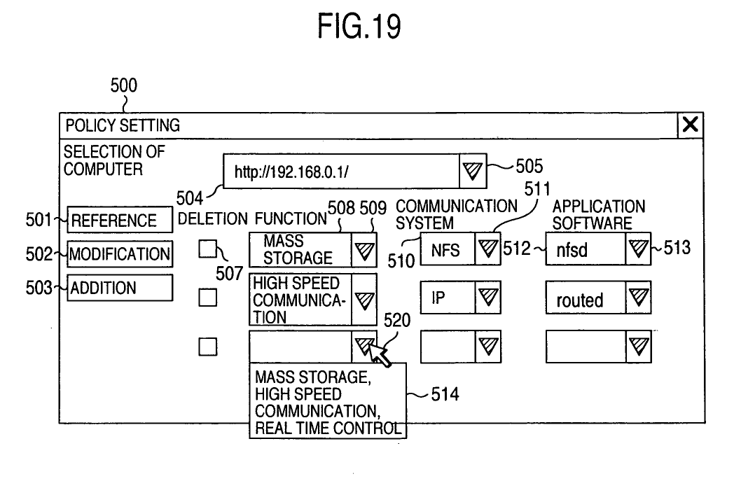

FIG. 19 shows the output window when the reference button 501 is pushed down in the policy setting tool 500.

FIG. 19 shows the window when the information contained in the policy information 25 of the object computer is outputted when the object computer is selected as http://192.168.0.1/in the computer select button in FIG. 18B. In addition to the elements shown in FIG. 18A, the policy setting tool 500 includes a delete check box 507 for deleting this function, a function select menu 508 and a function select menu button 509 for selecting the functions, a communication system select menu 510 and a communication systems select menu button 511 for selecting the communication system and an application software select menu 512 and an application software select menu button 513 for selecting application software.

The column of each of the functions, the communication system and the application software is provided with the pull-down menu and these items can be modified. The item can be changed by operating the pull-down menu of the item that is desired to be modified. When it is desired to complete modification and to have the result reflected on the object computer, the user pushes down the modify button 502. The policy setting tool 500 transmits the modification content to the policy setting means 6 of the object computer.

Check is put to a deletion check box at the extreme left of the object item to delete the item. When the user pushes down the modify button 502, the policy setting tool 500 transmits the request to the policy setting means 26 of the object computer.

An empty item may be displayed on the lowermost row of the window in addition to the information contained in the policy information 25 to prepare for the addition of new functions. When any function is added, the function select menu button 509 of the empty item is pushed down by the cursor 520 and the name of the item that can be added is displayed by the pull-down menu 514. The function, the communication system and the application software are selected and the addition button 503 is finally pushed down. In consequence, the information about the item added is transmitted to the policy setting means 26 of the object computer.

A help button (not shown) may be disposed if any ambiguous point remains for these set items. The help information about the selected item is balloon-displayed at the cursor position when the help button is pushed down and the item is selected, or is displayed on a separate window. This will be helpful to the user.

This system can be similarly applied to not only policy information setting but also server information setting. In other words, the present invention can be applied by setting the computer as the selection object to the sever computer and the objects of reference, modification and addition to the functions provided by the server computer. In this case, those functions of the server computer which are provided to the server computer but are not desired to be provided to external computers may be deleted. As for those functions which are desired to be provided, on the contrary, the items of such functions may be added.

As described above, the invention makes it possible to add or modify and delete the functions which are required by the object computer by merely selecting the menu even when the user does not have special knowledge about the computer as the setting object and its functions. As a result, utilization of the functions of a plurality of computers can be easily accomplished among these computers in a network system including a plurality of such computers.

### Embodiment 3

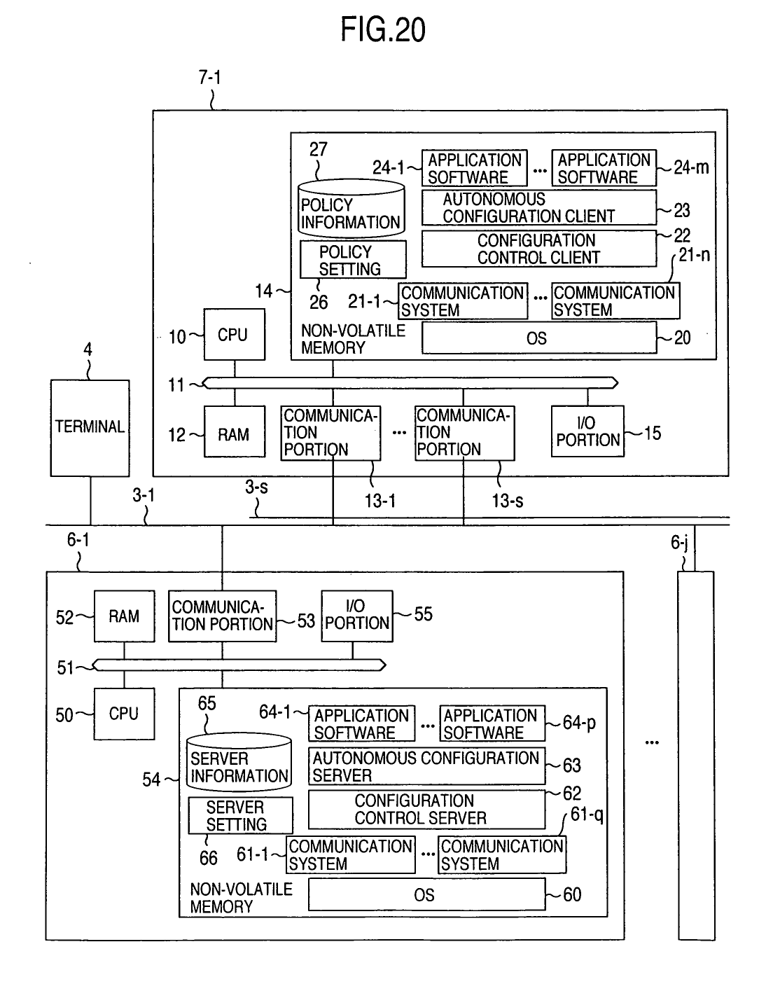

FIG. 20 shows a construction of a computer system according to the third embodiment of the invention. Reference numerals used in this embodiment have the same meaning as the functions and elements explained in the first and second embodiments unless specified otherwise.

The feature of this embodiment resides in that the client computer 7 has a plurality of communication portions (s portions) 13-1 to 13-s and is connected to a plurality of networks 3-1 to 3-s. Another feature is that the client computer 7 has policy information 27 corresponding to these communication portions. The server computer 6 may similarly have a plurality of communication portions according to the invention but the explanation will be omitted because the situation is the same as that of the client computer.

A plurality of communication portions 13-1 to 13-s of the client computer 7 is for the connection with a plurality of networks 3-1 to 3-s. Here, the communication portion and the network may be a virtual communication portion and a virtual network besides a physical communication portion and a physical network.

It is possible to prepare a corresponding communication portion for a virtual network by a Virtual Private Network (VPN) technology. According to this VPN, the network that is physically the same can be handled logically as a plurality of networks. The advantage brought forth by using the VPN is the prevention of wire tapping by ciphering data flowing through a communication path that is a logically different network. A malicious access from a non-secure communication path can be shut out by providing or utilizing the function for only a secure network.

According to another example, the client computer 7 may have physically different networks such as the Ethernet (R) and the field net and may require the function suitable for each network. In this case, the Ethernet (R) is used for high speed communication whereas the field network is used for data transfer that needs real time control. A suitable computer system can thus be designed.

These communication portions 13-1 through 13-s can clarify the object by allocating a suitable device file. For example, the communication portions corresponding to the Ethernet (R) are “eth0” and “eth1”, the communication portions corresponding to the VPN are “vpn0” and “vpn1” and the communication portions corresponding to the RS232C are “ttyS0” and “ttyS1”.

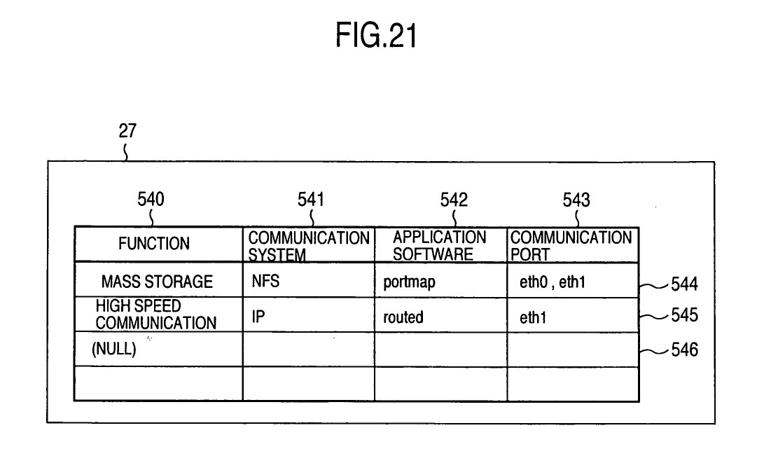

FIG. 21 shows a structural example of the policy information 27.

The policy information 27 has communication port information in addition to the construction of the policy information 25. In other words, the policy information has information about the function 540 the client computer 7-1 utilizes, the communication system 541, the application software 542 and the communication port 543.

The example shown in FIG. 21 represents the description of two functions and a terminal symbol (NULL). Description 544 about “mass storage” and description 545 about “high speed communication” are shown as the functions that the client computer 7-1 utilizes.

The description 546 about the terminal symbol (NULL, binary value “0”) represents that the function utilized by the client computer 7-1 no longer exists. The terminal symbol is not particularly limited to the NULL symbol as long as it can clarify the terminal.

The description 544 represents that the client computer 7-1 needs the “mass storage” function, the communication system is NFS, the application software utilized is “portmap” and the communication system used for the communication may be either eth1 or eth0.

The description 545 represents that the client computer 7-1 needs the “high speed” function, the communication system is IP, the application software utilized is “routed” and the communication portion used for communication is eth1. This is based on the assumption that the eth 1 is an interface corresponding to the high speed communication portion and is prepared on the basis of the concept that an interface having a sufficient transfer speed must be used to utilize the high speed communication function.

These kinds of information are handed over to the autonomous configuration client 23 and are used for retrieving the computer having such functions and for the subsequent start-up processing of the application software.

The policy information 27 in this embodiment may be prepared in advance as a file or may be constituted by the policy setting means 26. The format of the file recorded may be a text file format divided by tabs and commas or a binary file form. The policy information 27 need not always be an independent file but may be other setting information or a format contained in a script file.

The invention can provide the autonomous configuration that makes it possible to utilize various functions from only a suitable communication portion in such a fashion as to correspond to a plurality of communication portions including a high speed communication path and a secure communication path. As a result, it becomes possible to provide the restriction that the high speed communication can be utilized through only the high speed network and mass storage having high security can be utilized through only the secure network. Accordingly, the invention can easily constitute a computer system that is excellent in flexibility.

In each of the foregoing embodiments, the mechanism of UPnP can be utilized for packaging the configuration control client 22 and the configuration control server 62. In such a case, the communication processing function by the HTTP server or SOAP for realizing UPnP must be packaged to the configuration control client 22 and the configuration control server 62. The program memory used can be decreased because packaging of the HTTP server utilized by other functions such as the policy setting means 26 and the server information setting means 66 can be also used.

It should be further understood by those skilled in the art that although the foregoing description has been made on embodiments of the invention, the invention is not limited thereto and various changes and modifications may be made without departing from the spirit of the invention and the scope of the appended claims.

1. A computer system having a plurality of computers connected through a network, wherein
a first computer comprises a server computer including:
a communication portion connected to said network, for executing communication with other computers;
a server information table having information about a function said first computer can provide by itself, a communication system for utilizing said function and application software for utilizing said function; and
an autonomous configuration server function for acquiring said function said first computer can provide by itself from said server information table in response to a function retrieval request from the other computer, and receiving and setting the setting request about said function, and
said server computer autonomously processes said function retrieval request and said setting request from the other computers.

2. A computer system having a plurality of computers connected through a network, wherein
a second computer comprises a client computer including:
a communication portion connected to said network, for executing communication with other computers;
a policy information table having information about a function required by said second computer by itself, a communication system for utilizing said function and application software for utilizing said function; and
an autonomous configuration client function for acquiring said required function from said policy information table, outputting a function retrieval request to other computers through said communication portion and outputting a setting request for utilizing said function through said communication portion when said required function is discovered, and
said client computer autonomously discovers and utilizes said functions of the other computers.

3. A computer system having a plurality of computers connected through a network, wherein
a first computer comprises a server computer including:
a communication portion connected to said network, for executing communication with other computers;
a server information table having information about a function said first computer can provide by itself, a communication system for utilizing said function and application software for utilizing said function; and
an autonomous configuration server function for acquiring said function said first computer can provide by itself from said server information table in response to a function retrieval request from the other computer, and receiving and setting said setting request about said function,
a second computer comprises a client computer including:
a communication portion connected to said network, for executing communication with other computers;
a policy information table having information about a function required by said second computer by itself, a communication system for utilizing said function and application software for utilizing said function; and
an autonomous configuration client function for acquiring said required function from said policy information table, outputting a function retrieval request to other computers through said communication portion and outputting a setting request for utilizing said function when said required function is discovered, and
said second computer autonomously discovers and utilizes said functions of said first computers.

4. The server computer according to claim 1, further comprising server information setting means for modifying said server information table, wherein said server computer updates said server information table.

5. The client computer according to claim 2, further comprising policy information setting means for modifying said policy information table, wherein said client computer updates said policy information table.

6. The server computer according to claim 4, wherein said server computer accepts a modify request for said server information table through HTTP.

7. The client computer according to claim 5, wherein said client computer accepts a modify request for said policy information table through HTTP.

8. A computer system having a plurality of computers connected through a network, wherein
a first computer comprises a server computer including:
a plurality of communication portions connected to said network, for executing communication with other computers;
a server information table having a function said first computer can provide by itself, a communication system for utilizing said function, application software for utilizing said function and communication portion information providing said function; and
an autonomous configuration server function for acquiring said function said first computer can provide by itself from said server information table for a request from said communication portion coincident with said communication portion information in response to a function retrieval request from the other computer, and receiving and setting the setting request about said function, and
said server computer autonomously processes said function retrieval request and said setting request from the other computers.

9. A computer system having a plurality of computers connected through a network, wherein
a second computer comprises a client computer including:
a plurality of communication portions connected to said network, for executing communication with other computers;
a policy information table having a function said second computer can provide by itself, a communication system for utilizing said function, application software for utilizing said function and communication portion information providing said function; and
an autonomous configuration client function for acquiring said function said second computer can provide by itself from said client information table for a request from said communication portion coincident with said communication portion information in response to a function retrieval request from the other computer, and receiving and setting said setting request about said function, and
said client computer autonomously processes said function retrieval request and said setting request from the other computers.

10. A computer system having a plurality of computers connected through a network, wherein
a first computer comprises a server computer including:
a plurality of communication portions connected to said network, for executing communication with other computers;
a server information table having information about a function required by said first computer by itself, a communication system for utilizing said function, application software for utilizing said function, communication portion information for utilizing said function; and
an autonomous configuration server function for acquiring said required function from said server information table, outputting a function retrieval request for other computers through said communication portion coincident with said communication portion information and outputting a setting request for utilizing said function when said required function is discovered,
a second computer comprises a client computer including:
a plurality of communication portions connected to said network, for executing communication with other computers, a policy information table having information about a function required by said second computer by itself, a communication system for utilizing said function, application software for utilizing said function and communication portion information for utilizing said function; and
an autonomous configuration client function for acquiring the required function from said policy information table, outputting a function retrieval request to other computers from a communication portion coincident with said communication portion information, and outputting a setting request for utilizing said function when said required function is discovered, and
said second computer autonomously discovers and utilizes said functions of said first computers.

11. The server computer according to claim 8, further comprising server information setting means for modifying said server information table, wherein said server computer updates said server information table.

12. The client computer according to claim 9, further comprising policy information setting means for modifying said policy information table, wherein said client computer updates said policy information table.

13. The server computer according to claim 11, wherein said server computer accepts a modify request for said server information table by HTTP.

14. The client computer according to claim 12, wherein said client computer accepts a modify request for said client information table by HTTP.
